(19) United States
(12) Patent Application Publication
(10) Pub. No.: US 2010/0067338 A1
(43) Pub. Date: Mar. 18, 2010

(54) Method of Determining the Quality of Data on an Optical Disc

(75) Inventor: Willem Arie Roos, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Lite-On IT Corporation, Taipei City (TW)

(21) Appl. No.: 12/543,186

(22) Filed: Aug. 18, 2009

Related U.S. Application Data
(60) Provisional application No. 61/096,923, filed on Sep. 15, 2008.

(51) Int. Cl. G11B 27/36

(52) U.S. Cl. 369/53.2; G9B/27.052

(57) ABSTRACT

The invention relates to a method of determining the quality of data on an optical disc. The method comprises performing a quality scan resulting in quality information about at least part of the data on the optical disc; organizing the quality information in groups, each group comprising quality information corresponding to a predetermined zone on the optical disc; and computing a zone quality information parameter for each group based on the quality information corresponding to that group.

### CROSS REFERENCE TO RELATED PATENT APPLICATION

This patent application is based on a U.S. provisional patent application No. 61/096,923 filed on Sep. 15, 2008, incorporated herein for reference.

### FIELD OF THE INVENTION

The invention relates to a method of determining the quality of data on an optical disc, an optical data system arranged to receive an optical disc OD and perform read actions on the optical disc OD. The invention further relates to a computer program, and a computer readable medium, comprising such a computer program.

### BACKGROUND OF THE INVENTION

In an optical disc drive, data can be written on optical disc media (such as a CD, DVD, Blu ray Disc (BD), HD DVD, DVD-RAM . . . ) from now on also referred to as optical disc or disc. To read or write data from/to the disc, a laser-based optical pick-up unit (OPU) may be used. This optical pick-up unit (OPU) may be arranged to generate a laser beam and to scan the laser beam over the surface of the disc to read from or write data to the disc.

The optical disc is composed of several layers, at least comprising two functional layers. A first layer is an information layer, which comprises the data or on which data can be written. A second layer is a protection layer. This protection layer is basically a substrate, which separates and therefore also protects the information layer from the outside world. The laser beam of the optical pick-up unit OPU will pass through this protective substrate to read data from or write data to the information layer of the disc.

The optical disc may be placed in the optical disc drive and forms an interchangeable and cheap data storage medium. The disc drive may function under control of a host, for instance a software tool running on a personal computer, in which the disc drive is positioned. The host and the optical disc drive together may form an optical data system.

When such an optical disc is used for long-term storage/archiving of data it is important, the quality of the data is checked before storing the optical disc, e.g. for several years. Also after several years of storage, a user may want to check the quality of the optical disc to see if the quality of the data is still good enough to store it for another so many years. Thus, the need for an optical disc quality check is twofold.

So, in many cases it is desirable to perform a quality scan of the optical disc in which the quality of all the or at least a substantial part of the data that has been written to the optical disc is checked.

The quality scan results are so called quality information, for instance in the form of error statistics from ECC blocks (Error Correction Code Block). When executing such a quality scan, a lot of data is checked and the amount of quality information may therefore amount to a relatively big that can not be interpreted easily by a user.

### SUMMARY OF THE INVENTION

It is an object to provide a method of performing a quality scan of data written on an optical disc that can be presented to a user in a user-friendly way.

According to an aspect there is provided a method of determining the quality of data on an optical disc, wherein the method comprises:

performing a quality scan resulting in quality information about at least part of the data on the optical disc;

organizing the quality information in groups, each group comprising quality information corresponding to a predetermined zone on the optical disc; and

computing a zone quality information parameter for each group based on the quality information corresponding to that group.

According to a further aspect there is provided an optical data system arranged to receive an optical disc and perform read actions on the optical disc, wherein the optical data system is arranged to:

perform a quality scan resulting in quality information about at least part of the data on the optical disc;

organise the quality information in groups, each group comprising quality information corresponding to a predetermined zone on the optical disc; and

compute a zone quality information parameter for each group based on the quality information corresponding to that group.

According to a further aspect there is provided a computer program, when loaded on a computer arrangement, is arranged to perform the method described above and there is provided a computer readable medium, comprising such a computer program.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a computer arrangement according to an embodiment,

FIG. 2 schematically depicts a flow diagram according to an embodiment,

FIG. 3 schematically depicts an optical disc OD according to an embodiment,

FIG. 4 schematically depicts a graph in accordance to an embodiment.

### DETAILED DESCRIPTION OF THE PREFERRED EMBODIMENT

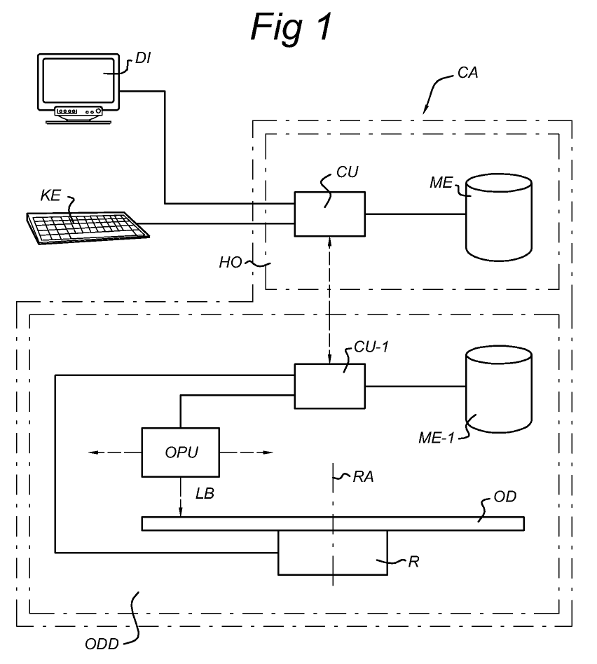

FIG. 1 schematically depicts a computer arrangement CA. The computer arrangement CA may comprise a control unit CU. The control unit CU may be or comprise a processor as is known to a skilled person. When functioning as a host, the control unit CU of the computer arrangement CA may be arranged to control the optical disc drive ODD. The control unit CU may comprise or have access to a memory ME. The memory ME may comprise programming lines that are readable and executable by the control unit CU to perform one or more of the embodiments presented here. The memory ME may also comprise data that is to be written on the optical disc OD. The memory ME may be of any suitable type, such as ROM, RAM, EPROM etc.

As will be understood by a skilled person, the computer arrangement CA may further be arranged to be connected to peripheral equipment, such as a display DI and a keyboard KE to allow user interaction.

As already mentioned above, the computer arrangement CA may function as a host HO, for instance by means of an appropriate software tool. The computer arrangement CA may further comprise an optical disc drive ODD. The optical disc drive ODD may be arranged to receive an optical disc OD and perform read and write actions on the optical disc OD. The host HO may be arranged to instruct the optical disc drive ODD to read or write data to the optical disc OD. Together, the host HO and the optical disc drive ODD may function as an optical storage system.

The optical disc drive ODD as shown in FIG. 1 comprises an optical disc OD, such as a CD, DVD, Blu ray Disc (BD), HD DVD etc. The optical disc OD is usually substantially disc shaped, i.e. substantially round with a hole in the middle to allow the optical disc drive ODD to receive and actuate (rotate) the optical disc OD.

The optical disc drive ODD comprises an optical pick-up unit OPU, arranged to generate a beam, such as a laser beam LB, to be scanned over the surface of the optical disc OD to read data from or write data to the optical disc OD. The optical pick-up unit OPU may be arranged to generate a write beam to write data and a read beam to read data from the optical disc OD, where the write and read beam may have different powers or intensities.

The optical pick-up unit OPU is further arranged to move in a direction parallel to the surface of the optical disc OD, as indicated by the dashed arrows in horizontal direction according to FIG. 1. Also, the optical pick-up unit OPU and the optical disc OD may be arranged to move in a direction perpendicular to the surface of the optical disc OD with respect to each other to position the information layer of the optical disc OD in the focal plane of the laser beam LB.

The optical disc drive ODD further comprises at least one actuator, such as a rotation element R arranged to rotate the optical disc OD about a rotation axis RA. Also further actuators may be provided to accurately position the optical disc OD and the laser beam LB with respect to each other. The term actuator is used to refer to all kinds of devices that are arranged to set things in motion, such as hydraulic systems, robot arms etc.

The movements as performed by both the optical pick-up unit OPU and the rotation element R are controlled by a control unit CU-1 of the optical disc drive ODD such that the laser beam LB scans the surface of the optical disc OD in an appropriate way, for instance following a spiral path. The control unit CU-1 may be or comprise a processor as is known to a skilled person.

The control unit CU-1 of the optical disc drive ODD may further be arranged to control the optical pick-up unit OPU to read or write data to or from the optical disc OD. In case of a write operation, the control unit CU-1 may provide the optical pick-up unit OPU with the data that is to be written. In case of a read operation, the optical pick-up unit OPU may be arranged to transmit the data that is read from the optical disc OD to the control unit CU-1 for further processing.

The control unit CU-1 may comprise or have access to a memory ME-1 of the optical disc drive ODD. The memory ME-1 may comprise programming lines that are readable and executable by the control unit CU-1 to perform one or more of the embodiments presented here. The memory ME-1 may also comprise data that is to be written on the optical disc OD. The memory ME-1 may be of any suitable type, such as ROM, RAM, EPROM etc. Both the control unit CU of the host HO as the control unit CU-1 of the optical disc drive ODD may in fact be formed by than one control unit or processor working in cooperation with each other.

According to an embodiment of the present application, there is provided a method of determining the quality of data on an optical disc (OD), wherein the method comprises:

a) performing a quality scan resulting in quality information about at least part of the data on the optical disc (OD),

b) organizing the quality information in groups, each group comprising quality information corresponding to a predetermined zone on the optical disc (OD),

c) computing a zone quality information parameter for each group based on the quality information corresponding to that group.

According to a further embodiment, the method further comprises

d) outputting the zone quality information parameters.

The term outputting as used here encompasses outputting to a user (i.e. using a display or the like) and also encompasses outputting to a further internal or external device or functional block for further processing.

The methods according to the embodiments may be executed by the optical data system. Therefore, there is provided an optical data system arranged to receive an optical disc OD and perform read actions on the optical disc OD, wherein the optical data system is arranged to:

a) perform a quality scan resulting in quality information about at least part of the data on the optical disc OD,

b) organise the quality information in groups, each group comprising quality information corresponding to a predetermined zone on the optical disc OD,

c) compute a zone quality information parameter for each group based on the quality information corresponding to that group.

According to a further embodiment the optical data system is arranged to:

d) output the zone quality information parameters.

The optical data system may comprise a host HO and an optical disc drive ODD. The optical data system may be arranged to perform the methods by reading and executing programming lines that provide the optical data system with the functionality according to the embodiments. The different actions may be performed by the host HO or the optical disc drive ODD. For instance, action a) may be performed by the optical disc drive (possibly under control of the host HO), where actions b) c) and d) may be executed by the host HO. Of course, actions b), c) and d) may partially be executed by the optical disc drive ODD as well.

The quality scan may comprise scanning the optical disc OD by scanning the optical disc OD with an appropriate laser beam LB. During the quality scan the laser beam LB follows that track on the optical disc and quality information may be detected by monitoring the reflected laser beam and/or position error signals, such as tracking error signal TE and focus error signal FE.

To control the movements of the actuators, position error signals may be derived from reflected laser light coming from the optical disc OD. The signal used to control the actuator displacements in radial direction is called the tracking error signal TE. The signal used to control the actuator displacements in focus direction is called the focus error signal FE. For stable tracking performance, the tracking error signal TE and focus error signal FE should remain within certain predetermined limits. Also the amount of reflected light is monitored as it may be restricted within certain predetermined limits.

According to the way described above, defects like, such as scratches, fingerprints, and black dots etc. may be detected.

Moreover, during the quality scan process, the complete optical disc OD or only parts of the optical disc OD may be scanned.

A quality scan command may be used to start or abort the disc quality scan starting from a “Startaddress” to a “Endaddress”. The quality scan command may comprise information about where to start and where to end the quality scan. Also the status/progress and the results of the quality scan can be retrieved at any time during or after the quality scan. The optical disc (OD) may be one of a Compact Disc (CD), a Digital Versatile Disc (DVD), a Blu-ray disc (BD).

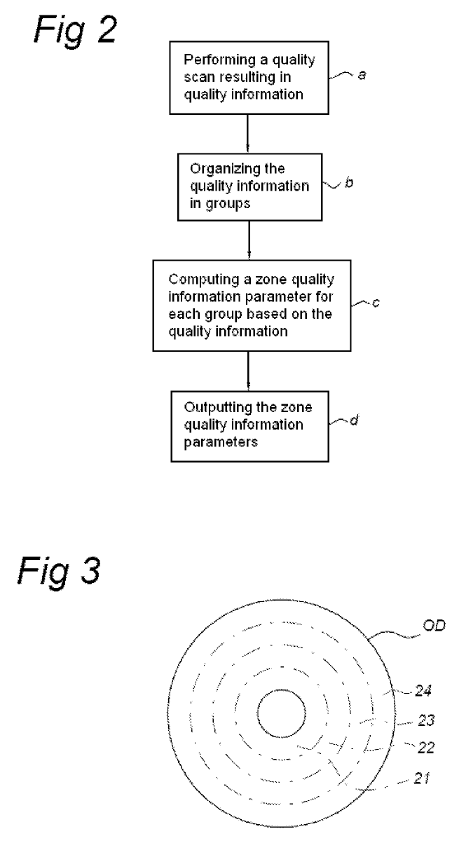

FIG. 2 schematically depicts a flow diagram as may be performed by the optical data system.

The quality scan may be performed by reading the data on the optical disc OD and measuring some properties of the written data, such as error statistics from ECC blocks (Error Correction Code Block) or jitter.

For CD, DVD and BD variants of the commonly known Reed Solomon Error correction code may be used. During the error correction process, the number of corrections and/or other correction process data in various stages of the error correction decoding process can be used as quality information or zone quality information parameters to keep track of the quality of the optical disc OD.

An important aspect of the quality of an optical disc is the margin before the data from the optical disc can not be read, i.e. when the error correction cannot correct the data properly. Therefore the errorstatistics data is well suited to judge the quality of the disc.

The zone quality information parameter may be provided in any suitable form or with respect to any suitable scale. The zone quality information parameter may be normalized, for instance by mapping it to a scale from 1-10. The term zone quality information parameter as used here covers all manifestations of the measured quality parameters.

According to an embodiment, the zones 21, 22, 23, 24 correspond to ring shaped zones, as schematically shown in FIG. 3. The zones are positioned concentrically with respect to the centre of the optical disc OD.

By organizing the quality information in groups it is possible to organize the quality information in a manageable way. The number of groups or zones may be chosen such that a representation of the quality over the optical disc OD can be given (not too few zones), bad parts of the optical disc OD can be pointed out accurately, and/or not too much zone quality data is produced (not too many zones).

Bad parts may be caused by scratches or dirt on the surface of the optical disc OD. Such bad parts may have a size in the range from a few tenths of a millimetre, up to several millimetres, in both radial and tangential direction.

It will be understood that the amount of zones has a direct influence on the amount of zone quality parameters that are generated. The amount of zone quality parameters is chosen to be a manageable amount, e.g. can be presented to a user and allows assessment by the user in a non-automated way (e.g. by reading it from the display DI).

The number (and thus size) of the zones may be chosen to allow a graphical representation thereof on a display, allowing easy analysis by a user.

Therefore, according to an embodiment, the amount of zones is in the range of 20 to 75, for instance in the range of 24 to 48. Table 1 provides an example of the amount of zones that may be chosen for different types of optical discs OD. The table 1 further shows the amount of data that is thus present in a zone, the number of frames in one zone and number of clusters in one zone.

TABLE 1

| | | | Nr of frames | Nr of Clusters |
|---|---|---|---|---|
| Disc type | Nr of zones | Zone size | in 1 zone | in 1 zone |
| CD | 40 | 17.5 Mbyte | 9000 (2 | 120 |
| (80 min. | | | minutes) | data seconds |
| disc) | | | | |
| DVD | 36 SL/66 DL | 128 Mbyte | 64K | 4096 |
| | | | | ECC-clusters |
| BD | 24 SL/48 DL | 1 Gbyte | 512K | 16384 |
| | | | | ECC-clusters |

(SL is single layer, DL is double layer)

It will be understood that having too few zones (e.g. 4 zones) may result in inaccurate zone quality parameters. A relatively bad area on the optical disc OD may be masked by relatively good area that is in the same zone as the bad area. Therefore, the zones may not be chosen too big.

On the other hand, having too many zones (e.g. 100 or more) will result in too many zone quality parameters that can not be presented in a user-friendly way to a user and do not allow assessment by the user e.g. by reading the zone quality parameters from the display DI.

Table 1 shows that the number of zones and the size of a zone (amount of Mbyte in a zone) may be different for CD, DVD and BD.

Furthermore, the boundaries between zones may be indicated by addresses having round numbers, for practical purposes. An example of this is shown in Table 2 for different types of optical discs OD. As will be understood by a skilled person, the address for CD's are in Minutes:Seconds:Frames format and the addresses for DVD and BD are Physical Block Adresses (PBA's).

TABLE 2

| Disc | | From | | |
|---|---|---|---|---|
| type | Zone nr. | address | To address | |
| CD | 0 | 00:00:00 | 02:00:00 | |
| | 1 | 02:00:00 | 04:00:00 | |
| | . . . | . . . | . . . | |
| | 39 | 79:00:00 | 80:00:00 | |
| DVD | 0 | 0x030000 | 0x040000 | |
| | 1 | 0x040000 | 0x050000 | |
| | . . . | . . . | . . . | |
| | 35 | 0x260000 | 0x270000 *1) | |
| | 40 | 0xDD0000 | 0xDE0000 | For the second layer |
| | . . . | . . . | . . . | if applicable |
| | 71 | 0xFC0000 | 0xFD0000 | |
| BD | 0 | 0x00100000 | 0x00180000 | |
| | 1 | 0x00180000 | 0x00200000 | |
| | . . . | . . . | . . . | |
| | 23 | 0x00C80000 | 0x00D00000 | |
| | 24 | 0x01300000 | 0x01380000 | For the second layer |
| | . . . | . . . | . . . | if applicable |
| | 47 | 0x01E80000 | 0x01F00000 | |

*1) For DVD dual-layer discs zones number 32 through 39 are not used since the capacity of one layer is smaller than for DVD single-layer discs. The first possible zone for the second layer is zone nr. 40

According to an embodiment, the zone quality information parameter is computed by averaging the quality information corresponding to each group. The quality scan may for instant result in quality information comprising one quality measure for each logical address. The quality measure may for instance be jitter. The zone quality information parameter may than be computed by averaging all the quality measures (in this case all jitter values).

For every zone, the ECC-block with the lowest quality may be considered, since this ECC-block is the one closest to becoming uncorrectable (weakest link). Besides it is possible to compute an average (sum of all quality measures divided by the number of measures) and put a limit to this. When the average zone quality is relatively low, it is more likely that one of the ECC-blocks will become uncorrectable over time.

According to another possibility, the quality of the zone is computed as follows:

QualityZone=100−((100−Q_{MAX})*(100−Q_{AVG})ⁿ⁻¹)^{1/n}

wherein:
n>0
QMAX is the maximum of all quality indices per ECC block computed in the zone.
QAVG is the average of all quality indices per ECC block computed in the zone.

In this example, for each quality index, zero corresponds with perfect quality and 100 corresponds to an uncorrectable quality.

In general, the quality information may comprise at least one of the following types of quality information Error Statistics, such as Error rates (e.g. BLER/SER; C1 and/or C2 for CD; PI and/or PO for DVD; LDC and/or BIS for BD; correctable errors, uncorrectables), Jitter (being e.g. data to data Jitter, Data to clock jitter, delta amplitudes on slicers, . . . ), Beta (asymmetry), or Modulation depth. The above (and other) types of quality information may be used to determine quality. It is possible to only use errorstatistics to determine quality, except when performing a surface scan on an empty optical disc. Of course, other types of quality information may be used.

According to an embodiment, action c) further comprises computing a zone quality information parameter, based on at least two types of quality information.

According to an embodiment, there is provided a method wherein action a) further comprises determining at least a first and a second ECC quality statistics value associated with an ECC code to form the quality information, wherein the first and second ECC quality statistics value comprise at least code words of a first type and code words of a second type, wherein the first ECC quality statistics value is associated with code words of the first type (C1; PI; LDC) and the second ECC quality statistics value being associated with code words of the second type (C2; PO; BIS) different from the first type.

And, action c) further comprises determining a plurality of weighted summations of the first and the second ECC quality statistics values for different ECC blocks within a group, and determining a maximum value of the plurality of weighted summations within the group to form the zone quality information parameter.

The weighted summation may also be referred to a ECC quality information parameter.

The zone quality information parameter thus determined may be outputted to inform a user or other software tool about the quality of the data present on the optical disc (action d).

Since different error correction techniques are used for different optical discs as BD, DVD, CD, different ECC quality statistics may be used as the at least first and second ECC quality statistics values. As ECC codes are known to a skilled person, these are not explained in further detail here.

Below the following definitions are used for an embodiment of the present application:

C1-errors (or C1-bler) is the number of C1 codewords in 1 datasecond (CD) that had 1 or more errors.

C2-errors (or C2-bler) is the number of C2 codewords in 1 datasecond (CD) that had 1 or more errors.

C1-uncorrectables is the number of C1 codewords in 1 datasecond (CD) that were uncorrectable.

Nbr of C2-unc is the number of datasecond-clusters with one or more C2 uncorrectable error. (this is an errorcorrection fail or datacorruption).

PI-bler is the number of PI codewords in 1 ECC-cluster (DVD) that had 1 or more errors.

PO-bler is the number of PO codewords in 1 ECC-cluster (DVD) that had 1 or more errors.

PI-unc is the number of PI codewords in 1 ECC-cluster (DVD) that were uncorrectable.

Nbr of PO-unc is the number of ECC-clusters (DVD) with one or more PO uncorrectable error (errorcorrection fail or datacorruption).

LDC-errata is the number of LDC error bytes in 1 ECC-cluster (BD).

LDC-erasures is the number of erasures in 1 ECC-cluster (BD). Erasures being the result of consecutive BIS errors.

BIS-errata is the number of BIS error bytes in 1 ECC-cluster (BD).

Nbr of LDC-unc is the number of ECC-clusters (BD) with one or more LDC uncorrectable error (this is an errorcorrection fail or datacorruption)

With respect to CD's a reference is added to Appendix C of Standard ECMA-130, Data Interchange on Read-only 120 mm Optical Data Disks (CD-ROM), 2^{nd} edition (June 1996) (http://www.ecma-international.org/publications/standards/Ecma-130.htm). According to this document the error correction encoding of the F1-frames is carried out by a Cross Interleaved Reed-Solomon Code (CIRC) encoder consisting of three delay sections and two encoders C1 (figure C.1) and C2 (figure C.2).

With respect to DVD's reference is made to paragraph 18 of Standard ECMA-267, 120 mm DVD—Read-Only Disk, 3^{rd} edition (April 2001) (http://www.ecma-international.org/publications/standards/Ecma-267.htm). According to this document an ECC Block is formed by arranging 16 consecutive Scrambled Frames in an array of 192 rows of 172 bytes each (FIG. 20 of the cited document). To each of the 172 columns, 16 bytes of Parity of Outer Code are added, then, to each of the resulting 208 rows, 10 byte of Parity of Inner Code are added. Thus a complete ECC Block comprises 208 rows of 182 bytes each. The bytes of this array are identified as Bi,j as follows, where i is the row number and j the column number:

Bi,j for i=0 to 191 and j=0 to 171 are bytes from the Scrambled Frames;

Bi,j for i=192 to 207 and j=0 to 171 are bytes of the Parity of Outer Code;

Bi,j for i=0 to 207 and j=172 to 181 are bytes of the Parity of Inner Code.

In other words, PI and PO bytes are parity bytes of rows and columns of the ECC-code of the DVD which are used to detect and/or correct errors in the rows and columns.

For DB reference is made to for instance page 23, 24 of WHITE PAPER, Blu-ray Disc, Recordable Format, Part 1, Physical Specifications, February, 2006 (http://www.blu-raydisc.com/Assets/Downloadablefile/BD-R_Physical_{—}3rd_edition_{—}0602f1-15268.pdf). According to this reference the LDC is Long Distance Code which is an ECC-code in which real data is stored; BIS is a Burst Indicator Symbol, which is an assistance-code which can be used to easily detect bursts.

According to the prior art for a CD, it is known to use a limit for the C1-bler; for a DVD, a limit for the PI-bler; and for a BD, a limit on the LDC-errata. However, in this way the method may be too strict for certain types of errors while being not strict enough for other type of errors. The embodiments described here provide a way to compute a measure that takes into account different types of errors correctly.

According to an embodiment, the first ECC quality statistics value is associated with at least a presence of random errors.

According to an embodiment, the second ECC quality statistics value is associated with at least a presence of burst errors.

The presence of errors may be measured e.g. as a number of errors, also referred to as errata, as determined from parities associated with corresponding code words.

The presence of errors may be measured e.g. as a number of uncorrectable errors as determined from parities associated with corresponding code words.

The presence of errors may be measured e.g. as a number of erasures as determined from parities associated with corresponding code words.

The ECC code may e.g. be a Cross-Interleaved Reed-Solomon Code of a so-called C1-code and a so-called C2-code for CD disks, as described in Standard ECMA-130.

The ECC code may e.g. be a Reed-Solomon Code using a so-called Parity of Inner Code (PI) and a so-called Parity of Outer Code (PO) for DVD disks, as described in Standard ECMA-267.

The ECC code may e.g. be a Picket-type ECC code using a so-called Long Distance Code (LDC) and a so-called Burst Indicator Symbol Code (BIS) for BD-disks, as will be understood by the skilled person.

Below a few examples are provided of how to compute a zone quality information parameter based on at least two types of quality information as described in general above.

### For a Blu-Ray Disc BD

The maximum number of bytes that can be corrected properly in one ECC-cluster depends on how the errors are distributed or spatially divided over the ECC-cluster. In case the Errors are randomly spread over the ECC-cluster it is possible to correct about 1600 bytes in one ECC-cluster. In case the errors are in groups of consecutive errorbytes (burst errors), it is possible to correct over 9000 bytes. These numbers come from simulations that are also verified in a practical situation.

This way for every type of optical disc defect, the maximum number of errors that can be corrected can be determined, which may be referred to as the safe maximum number of errors.

It is possible to keep a safe margin factor of 50% or 25% respectively of the maximum number of errors for the type of defect that is applicable may be observed.

The Tables 3a, 3b, 3c indicate the “safe” maximum number of LDC-errors in one ECC cluster for different types of defects, and also the resulting LDC-errata and LDC-bursterrors. Table 3a relates to the maximum number of errors for the type of defect that is applicable, and Table 3b-3c relate to a safe margin factor of 2 and 4 respectively (50% and 25%).

TABLE 3a
The number of LDC-errors is set to 100% of the “Safe” maximum number

| | | | | | | | Very | Multi | Single |
|---|---|---|---|---|---|---|---|---|---|
| | | | Hair | Bad-rf + | Light | Deep | Deep | Black | Black |
| | Random | Bad-rf | Scratch | Scratch | Scratch | Scratch | Scratch | Dots | Dots |
| LDC | 1600 | 1650 | 1720 | 2000 | 2100 | 3500 | 5000 | 6600 | 9120 |
| errata | | | | | | | | | |
| LDC | 32 | 32 | 70 | 500 | 650 | 2400 | 4600 | 6400 | 9078 |
| burst | | | | | | | | | |
| 6*err- | 9440 | 9740 | 9970 | 9500 | 9350 | 9000 | 7000 | 7600 | 9330 |
| 5*burst | | | | | | | | | |

TABLE 3b
The number of LDC-errors is set to 50% of the “Safe” maximum number

| | | | | | | | Very | Multi | Single |
|---|---|---|---|---|---|---|---|---|---|
| | | | Hair | Bad-rf + | Light | Deep | Deep | Black | Black |
| | Random | Bad-rf | Scratch | Scratch | Scratch | Scratch | Scratch | Dots | Dots |
| LDC | 800 | 825 | 875 | 1000 | 1050 | 1750 | 2500 | 3300 | 4560 |
| errata | | | | | | | | | |
| LDC | 10 | 10 | 23 | 250 | 325 | 1200 | 2300 | 3100 | 4539 |
| burst | | | | | | | | | |
| 6*err- | 4750 | 4900 | 5135 | 4750 | 4675 | 4500 | 3500 | 4300 | 4665 |
| 5*burst | | | | | | | | | |

TABLE 3c
The number of LDC-errors is set to 25% of the “Safe” maximum number

| | | | | | | | Very | Multi | Single |
|---|---|---|---|---|---|---|---|---|---|
| | | | Hair | Bad-rf + | Light | Deep | Deep | Black | Black |
| | Random | Bad-rf | Scratch | Scratch | Scratch | Scratch | Scratch | Dots | Dots |
| LDC | 400 | 412 | 437 | 500 | 525 | 875 | 1250 | 1650 | 2280 |
| errata | | | | | | | | | |
| LDC | 4 | 4 | 10 | 115 | 162 | 570 | 1140 | 1450 | 2242 |
| burst | | | | | | | | | |
| 6*err- | 2380 | 2452 | 2572 | 2425 | 2340 | 2400 | 1800 | 2650 | 2470 |
| 5*burst | | | | | | | | | |

According to this embodiment there is provided a method wherein action a) further comprises determining at least a first and a second ECC quality statistics value associated with an ECC code to form the quality information, wherein the first and second ECC quality statistics value comprise at least code words of a first type and code words of a second type, wherein the first ECC quality statistics value is associated with LDC-errate errors, and the second ECC quality statistics value being associated with LDC-burst errors.

And, action c) further comprises determining a plurality of weighted summations of the first and the second ECC quality statistics values for different ECC blocks within a group, and determining a maximum value of the plurality of weighted summations within the group to form the zone quality information parameter.

It is noted here that the parameters LDC-errata and LDC-burst are used. For LDC-burst, it is noted that it is determined using consecutive BIS errors.

According to this embodiment, the weighted summation of the first and the second ECC quality statistics values is determined using the following formula:

ECCQualInfoParameter=CorrFactor*(a*LDC_errata−β*LDC_burst).

The correction factor may be used to obtain a normalized ECC quality information parameter and may take into account the safe margin factor used, i.e. the threshold of for instance 50% or 25% of the maximum number of errors for the type of defect that is applicable. An ECC cluster is considered safe when the ECC quality information parameter meets a predetermined quality threshold.

For the examples provided, α may be chosen equal to 6, and β may be chosen equal to 5, and the correction factor CorrFactor may be 0.01 in case a safe margin factor equal to one is applied; 0.02 in case a safe margin factor of 2 (50%) is used and 0.04 in case a safe margin of 4 (25%) is used, thereby normalizing the ECC quality information parameter with respect to a quality threshold of 100, meaning that an ECC block can be considered safe if the ECC quality information parameter <100, for different kind of error types. Of course, other quality thresholds may be used.

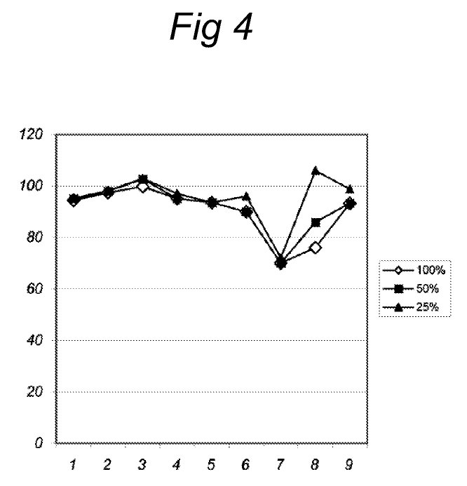

FIG. 4 schematically shows that the quality threshold is approximately equal to 100 for all identified types of defects. All points in the graph are derived from the tables above with simulated errorstatistics.

It will be understood that the values of α and β may be chosen to obtain a useful quality information parameter. The values used in this example (α=6; β=5) are just an example.

Next, a zone quality information parameter may be determined for the plurality of weighted summations within the group to form the zone quality information parameter by determining a maximum value of the plurality of weighted summations within the group.

### For a CD

A similar example can be provided for a CD. Again, the maximum number of bytes that can be corrected properly in one Data second (CD) depends on how the errors are distributed or spatially divided.

In case the Errors randomly spread, about 2000 bytes are correctable in one Data second, in case the errors in groups of consecutive errorbytes (burst errors), about 600 bytes can be corrected. These numbers come from simulations that are also verified in a practical situation.

This way for every type of disc defect, the maximum number of errors that can be corrected can be determined, referred to as the safe maximum number of errors. In case you want to keep a margin factor 2, one should not exceed 50% of the maximum number of errors for the type of defect that is applicable. For a factor 4 margin one should not exceed 25% of the maximum.

Table 4 indicates the “safe” maximum number of errors in one Data second for different types of defects, and also the resulting C1-errors, C1-uncors and C2-errors.

TABLE 4

| | | | | | | Very | |
|---|---|---|---|---|---|---|---|
| | | | Hair | Light | Deep | Deep | Bad-rf & |
| 100% MF = 1 | Random | Bad-rf | Scratches | Scratches | Scratches | Scratch | Scratch |
| Total | 3200 | 2450 | 300 | 426 | 474 | 537 | 616 |
| C1-errors | 2600 | 2000 | 60 | 51 | 35 | 22 | 305 |
| C1-uncors | 68 | 56 | 52 | 45 | 32 | 21 | 45 |
| C2-errors | 185 | 155 | 255 | 355 | 400 | 430 | 277 |

| | Multi Black Dot | | | Single Black Dot | | | Bad-rf & SBD | | |
|---|---|---|---|---|---|---|---|---|---|
| 100% MF = 1 | 3 r. | 5 r. | 9 r. | 3 r. | 5 r. | 9 r. | 3 r. | 5 r. | 9 r. |
| Total | 612 | 600 | 594 | 762 | 1270 | 2286 | 628 | 850 | 1300 |
| C1-errors | 36 | 48 | 70 | 27 | 44 | 80 | 165 | 160 | 170 |
| C1-uncors | 34 | 43 | 64 | 26 | 43 | 79 | 18 | 26 | 45 |
| C2-errors | 500 | 508 | 498 | 345 | 575 | 1043 | 336 | 560 | 1003 |

According to this embodiment, there is provided a method wherein action a) further comprises determining at least a first and a second ECC quality statistics value associated with an ECC code to form the quality information, wherein the first and second ECC quality statistics value comprise at least code words of a first type and code words of a second type, wherein the first ECC quality statistics value is associated with C1-errors and the second ECC quality statistics value being associated with C1-uncors.

And, action c) further comprises determining a plurality of weighted summations of the first and the second ECC quality statistics values for different ECC blocks within a group, and determining a maximum value of the plurality of weighted summations within the group to form the zone quality information parameter.

According to a further embodiment, a third ECC quality statistics value associated with the ECC code is determined, wherein the third ECC quality statistics value comprises at least code words of a third type wherein the third ECC quality statistics value is associated with C2-errors.

According to this embodiment, the weighted summation of the first and the second ECC quality statistics values is determined using the following formula:

ECCQualInfoParameter=CorrFactor*(C1−errors+α′*C1−uncors+β′*C2−errors)

By carefully selecting the α′ and β′, the ECC quality information parameter may be mapped to a scale, allowing comparison of the ECC quality information parameters for different type of errors to a given quality threshold (e.g. of 100). The correction factor could take into account a desired safety margin. Also, the parameters α′ and β′ may depend on the margin factor, for instance:

a=14−marginfactor/4

b=7−marginfactor/12.

According to an embodiment, C2-errors are clipped at level=(300/marginfactor), where in case C2-errors>(300/mf) then C2-errors=(300/mf).

### For a DVD

The maximum number of bytes that can be corrected properly in one ECC-block (DVD) depends on how the errors are distributed or spatially divided over the ECC-block. In case the Errors are randomly spread over the ECC-block, one can correct about 800 bytes in one ECC-block; in case the errors are in small groups of consecutive errorbytes (in the case of light scratches on the disc), one can correct only 480 bytes.

These numbers come from simulations that are also verified in a practical situation.

This way for every type of disc defect, the maximum number of errors that can be corrected can be determined. This is referred to as the safe maximum number of errors.

In case one wants to keep a factor 2 margin, one should not exceed 50% of the maximum number of errors for the type of defect that is applicable. For a factor 4 margin one should not exceed 25% of the maximum etc.

The Table 5a indicates the “safe” maximum number of errorbytes in one ECCblock for different types of defects, and also the resulting PI-bler, PO-bler and Piunc for a margin factor equal to 1, where Table 5b shows the same for a margin factor equal to 2.

TABLE 5a

| | | | | | | | Very | Multi | Single |
|---|---|---|---|---|---|---|---|---|---|
| | | | Hair | Bad-rf + | Light | Deep | Deep | Black | Black |
| | Random | Bad-rf | Scratch | Scratch | Scratch | Scratch | Scratch | Dots | Dots |
| Bytes | 800 | 800 | 630 | 680 | 480 | 480 | 840 | 1100 | 1450 |
| PI-bler | 203 | 196 | 146 | 154 | 60 | 19 | 9 | 11 | 9 |
| PO-bler | 140 | 155 | 155 | 164 | 162 | 176 | 182 | 182 | 182 |
| Piunc | 38 | 45 | 39 | 28 | 31 | 15 | 9 | 11 | 9 |

TABLE 5b

| | | | | | | | Very | Multi | Single |
|---|---|---|---|---|---|---|---|---|---|
| | | | Hair | Bad-rf + | Light | Deep | Deep | Black | Black |
| | Random | Bad-rf | Scratch | Scratch | Scratch | Scratch | Scratch | Dots | Dots |
| Bytes | 400 | 400 | 315 | 340 | 240 | 240 | 420 | 550 | 725 |
| PI-bler | 177 | 158 | 95 | 105 | 33 | 10 | 5 | 9 | 5 |
| PO-bler | 16 | 50 | 90 | 116 | 119 | 142 | 180 | 180 | 182 |
| Piunc | 3 | 9 | 15 | 12 | 16 | 8 | 5 | 8 | 5 |

The following is noted:

1. The Quality of the disc is determined by the number of errors in relation to the maximum number of errors that may be allowed, e.g. that may still be correctable.

2. The maximum number of Errors depends on the type of Defect.

3. The type of defect in combination with the number of errors determines the PI-bler, PO-bler and PI-unc.

The 3rd rule can also be reversed, therefore to from the number of, and the ratio between PI-bler, PO-bler and PI-unc, and one can determine (or estimate) both the type of defect and the number of errorbytes.

According to this embodiment, there is provided a method wherein action a) further comprises determining at least a first and a second ECC quality statistics value associated with an ECC code to form the quality information, wherein the first and second ECC quality statistics value comprise at least code words of a first type and code words of a second type, wherein the first ECC quality statistics value is associated with PI-bler and the second ECC quality statistics value being associated with PO-bler.

And, action c) further comprises determining a plurality of weighted summations of the first and the second ECC quality statistics values for different ECC blocks within a group, and determining a maximum value of the plurality of weighted summations within the group to form the zone quality information parameter.

According to a further embodiment, a third ECC quality statistics value associated with the ECC code is determined, wherein the third ECC quality statistics value comprises at least code words of a third type wherein the third ECC quality statistics value is associated with PI-unc.

According to this embodiment, the weighted summation of the first and the second ECC quality statistics values is determined using the following formula:

ECCQualInfoParameter=CorrFactor*(α″*Pibler+Pobler+β″*Piunc).

By carefully selecting the α″ and β″, the ECC quality information parameter may be mapped to a scale, allowing comparison of the ECC quality information parameters for different type of errors to a given quality threshold (e.g. of 100). For instance:

a=Sqrt (marginfactor−1),

b=3̂(LN(marginfactor)/LN(2)),

and with 1<=‘marginfactor’<=16

When analysed, the above approach for DVD as described above may not work out perfectly for “Multi black dot” situations in combination with higher “Margin factor” (Margin factor=16). This is the situation with more black dots within one ECCblock and where every black dot is just long enough to result in a Piuncorrectable. This situation of errors will be in fact rejected too early, but it is a theoretical situation that will be fairly improbable in practice.

### Computer Program

According to a further embodiment, there is provided a computer program, when loaded on a computer arrangement, is arranged to perform any one of the methods described above. Further provided is a computer readable medium, comprising such a computer program.

### Further Remarks

The embodiments provided here are all explained with reference to optical discs OD, such as BD, HD-DVD, DVD, DVD-RAM, CD drives. However, it will be understood that the embodiments may also be applicable to other memory types, such as data storage drives etc. In general, the embodiments may all be applicable to any kind of arrangement for writing data to a memory type, such as writeable and rewritable media.

It will be understood that the division of the optical disc OD into zones in combination with performing a quality scan allows reporting back the result of the quality scan using the zones, as small enough parts of the optical disc for which the quality can be reported. This results in a limited but practical amount of data.

Furthermore, it will be understood that the embodiment may be performed by a combination of the host HO and the optical disc drive ODD, the host HO controlling the optical disc drive ODD.

The descriptions above are intended to be illustrative, not limiting. Thus, it will be apparent to one skilled in the art that modifications may be made to the invention as described without departing from the scope of the claims set out below.

What is claimed is:

1. A method of determining the quality of data on an optical disc, wherein the method comprises steps of:
performing a quality scan resulting in quality information about at least part of the data on the optical disc,
organizing the quality information in groups, each group comprising quality information corresponding to a predetermined zone on the optical disc,
computing a zone quality information parameter for each group based on the quality information corresponding to that group.

2. The method according to claim 1 further comprises step of outputting the zone quality information parameters.

3. The method according to claim 1, wherein the optical disc is one of a Compact Disc, a Digital Versatile Disc, and a Blu-ray disc.

4. The method according to claim 1, wherein the zones correspond to ring shaped zones, positioned concentrically with respect to a centre of the optical disc.

5. The method according to claim 1, wherein the amount of zones is in the range of 20-75

6. The method according to claim 1, wherein the amount of zones is in the range of 24-48.

7. The method according to claim 1, wherein the zone quality information parameter is computed by averaging the quality information corresponding to each group.

8. The method according to claim 1, wherein the quality information comprises at least one of the following types of quality information of Error Statistics, Jitter, Beta, or Modulation depth.

9. The method according to claim 8, wherein the computing step further comprises computing a zone quality information parameter, based on at least two types of quality information.

10. The method according to claim 1, wherein the performing step further comprises determining at least a first and a second ECC quality statistics value associated with an ECC code to form the quality information, wherein the first and second ECC quality statistics value comprise at least code words of a first type and code words of a second type, wherein the first ECC quality statistics value is associated with code words of the first type and the second ECC quality statistics value being associated with code words of the second type different from the first type.

11. The method according to claim 10, wherein the computing step further comprises determining a plurality of weighted summations of the first and the second ECC quality statistics values for different ECC blocks within a group; and determining a maximum value of the plurality of weighted summations within the group to form the zone quality information parameter.

12. The method according to claim 10, wherein the first ECC quality statistics value is associated with at least a presence of random errors.

13. The method according to claim 10, wherein the second ECC quality statistics value is associated with at least a presence of burst errors.

14. An optical data system arranged to receive an optical disc and perform read actions on the optical disc, wherein the optical data system is arranged to:
perform a quality scan resulting in quality information about at least part of the data on the optical disc,
organise the quality information in groups, each group comprising quality information corresponding to a predetermined zone on the optical disc,
compute a zone quality information parameter for each group based on the quality information corresponding to that group.

15. A computer program, when loaded on a computer arrangement, is arranged to perform any one of the methods according to claims 1-12.

16. A computer readable medium, comprising a computer program according to claim 1.
